(19) United States
(12) Patent Application Publication
(10) Pub. No.: US 2025/0074170 A1
(43) Pub. Date: Mar. 6, 2025

(54) INFORMATION PROCESSING DEVICE AND SYSTEM

(71) Applicant: TOYOTA JIDOSHA KABUSHIKI KAISHA, Toyota-shi (JP)

(72) Inventor: Yoshinori TAKAMURA, Nagoya-shi (JP)

(73) Assignee: TOYOTA JIDOSHA KABUSHIKI KAISHA, Toyota-shi (JP)

(21) Appl. No.: 18/739,343

(22) Filed: Jun. 11, 2024

(30) Foreign Application Priority Data
Aug. 28, 2023 (JP) 2023-138227

(51) Int. Cl. B60J 7/057; B60J 7/043

(52) U.S. Cl. CPC B60J 7/0573; B60J 7/043

(57) ABSTRACT

In the information processing device, weather information predicts rain or snow around the parking location of the target vehicle, the control unit determines whether there is a roof at the parking location. Further, when it is determined that there is no roof at the parking location, the control unit sends inquiry information for inquiring whether to close the open and close roof to the user of the target vehicle. When the control unit receives an instruction to perform close control of the open and close roof, the control unit closes the open and close roof of the target vehicle by remote control. On the other hand, when it is determined that there is a roof at the parking location, the control unit does not send the inquiry information.

### CROSS-REFERENCE TO RELATED APPLICATION

This application claims priority to Japanese Patent Application No. 2023-138227 filed on Aug. 28, 2023 incorporated herein by reference in its entirety.

### BACKGROUND

### 1. Technical Field

The present disclosure relates to remote control of an open and close roof of a vehicle.

### 2. Description of Related Art

Japanese Unexamined Patent Application Publication No. S61-241215 (JP S61-241215 A) discloses a technique related to automatic control of a sunroof of a vehicle. In the technique disclosed in JP S61-241215 A, the sunroof is closed by driving an opening and closing motor for the sunroof when rain is detected by a detection element mounted on the vehicle.

Japanese Unexamined Patent Application Publication No. 2013-049952 (JP 2013-049952 A) discloses a technique related to remote operations of a vehicle by a mobile information terminal. JP 2013-049952 A discloses that opening and closing of a sunroof of the vehicle is prohibited when weather information acquired based on the location coordinates of the vehicle indicates rain.

### SUMMARY

It is an object of the present disclosure to improve user convenience for remote control of an open and close roof of a vehicle.

An information processing device according to a first aspect of the present disclosure includes a control unit configured to
acquire location information of a parking location of a target vehicle with a remotely controllable open and close roof,
acquire information on an open and closed state of the open and close roof of the target vehicle,
acquire weather information around the parking location,
when the weather information predicts rain or snow around the parking location and the open and close roof of the target vehicle is open, determine based on the location information whether there is a roof covering the target vehicle at the parking location,
when determination is made that there is no roof covering the target vehicle at the parking location, send inquiry information inquiring whether to close the open and close roof to a user of the target vehicle, and
when an instruction to perform close control of the open and close roof is received from the user in response to the inquiry information, close the open and close roof of the target vehicle by remote control.
   The control unit does not send the inquiry information when determination is made that there is a roof covering the target vehicle at the parking location.

A system according to a second aspect of the present disclosure includes user equipment associated with a user of a target vehicle with a remotely controllable open and close roof; and an information processing device.
The information processing device is configured to
acquire location information of a parking location of the target vehicle,
acquire information on an open and closed state of the open and close roof of the target vehicle,
acquire weather information around the parking location,
when the weather information predicts rain or snow around the parking location and the open and close roof of the target vehicle is open, determine based on the location information whether there is a roof covering the target vehicle at the parking location,
when determination is made that there is no roof covering the target vehicle at the parking location, send inquiry information inquiring whether to close the open and close roof to the user equipment, and
when an instruction to perform close control of the open and close roof is received from the user equipment in response to the inquiry information, close the open and close roof of the target vehicle by remote control.
   The information processing device does not send the inquiry information to the user equipment when determination is made that there is a roof covering the target vehicle at the parking location.

According to the present disclosure, it is possible to improve user convenience for remote control of an open and close roof of a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a flow of information in a remote control system according to an embodiment;

FIG. 2 is a diagram illustrating an example of a table configuration of vehicle information;

FIG. 3 is a block diagram schematically illustrating a configuration of a management server;

FIG. 4 is a flowchart of information processing related to remote control for controlling a sunroof of vehicles; and

FIG. 5 is a diagram illustrating an example of a table configuration of vehicle information according to a modification of the embodiment.

### DETAILED DESCRIPTION OF EMBODIMENTS

In recent years, a technique for remotely controlling a target vehicle from a location away from the target vehicle has been developed. As the remote control, open and close control of an open and close roof of a vehicle can be exemplified. For example, when the target vehicle is parked, a user who is on the target vehicle may leave the control vehicle in a state where the user forgets to close the open and close roof. In such a case, the information processing device capable of remotely controlling the target vehicle inquires of the user whether to close the open and close roof by remote control. Then, when the information processing device receives an instruction to perform close control of the open and close roof from the user who is away from the target vehicle, the information processing device performs remote control to close the open and close roof.

However, there may be cases where it is not necessary to close the open and close roof by remote control even if the open and close roof is open in the parked target vehicle. When the user receives an inquiry as to whether or not to close the open and close roof by remote control even though there is no need to close the open and close roof, the user may feel troublesome. The present disclosure has been made in view of such problems.

An information processing device according to the present disclosure is an device for remotely controlling a target vehicle having a remotely controllable open and close roof. An information processing device according to the present disclosure includes a control unit. The control unit acquires the location information of the parking location of the target vehicle and the information on the open and closed state of the open and close roof of the target vehicle. The information processing device may receive the information from the target vehicle. Further, the control unit acquires weather information around the parking location of the target vehicle. At this time, the information processing device may receive the weather information of the area specified based on the parking location of the target vehicle from the external server that provides the weather information. The weather information includes information indicating whether rain or snow is predicted around the parking location of the target vehicle.

Further, the control unit determines whether there is a roof covering the target vehicle at the parking location when rain or snow is predicted around the parking location in the weather information and the open and close roof of the target vehicle is open. At this time, in the weather information, if the probability of precipitation within a predetermined time from the current time point in the area specified based on the parking location of the target vehicle is equal to or larger than the predetermined threshold value, it may be determined that rain or snow is predicted around the parking location. Further, the control unit determines whether there is a roof covering the target vehicle at the parking location based on the location information of the parking location of the target vehicle. For example, when the parking location of the target vehicle overlaps with the location of the building having the roof on the map, it may be determined that there is a roof covering the target vehicle in the parking location.

When it is determined that there is no roof covering the target vehicle at the parking location, the control unit sends the inquiry information. The inquiry information is information for inquiring whether or not to close the open and close roof to the user of the target vehicle. Further, when an instruction to perform the close control of the open and close roof is received from the user in response to the inquiry information, the control unit closes the open and close roof of the target vehicle by remote control. Accordingly, it is possible to prevent the inside of the target vehicle from getting wet due to rain or snow in a situation where there is no roof covering the parked target vehicle and the open and close roof of the target vehicle is open.

On the other hand, even when the open and close roof of the target vehicle in parking is open, if there is a roof covering the target vehicle, it is possible to prevent the inside of the target vehicle from being wet due to rain or snow. Therefore, when it is determined that there is a roof covering the target vehicle at the parking location, the control unit does not send the inquiry information. Accordingly, it is possible to reduce the possibility of unnecessary inquiries being made to the user regarding the remote control of the open and close roof. Therefore, according to the present disclosure, it is possible to improve convenience of a user regarding remote control of an open and close roof of a vehicle.

Hereinafter, an embodiment of the present disclosure will be described with reference to the drawings. The dimensions, materials, shapes, relative arrangements, and the like of the components described in the present embodiment are not intended to limit the technical scope of the present disclosure only thereto unless otherwise specified.

### EMBODIMENT

### System Overview

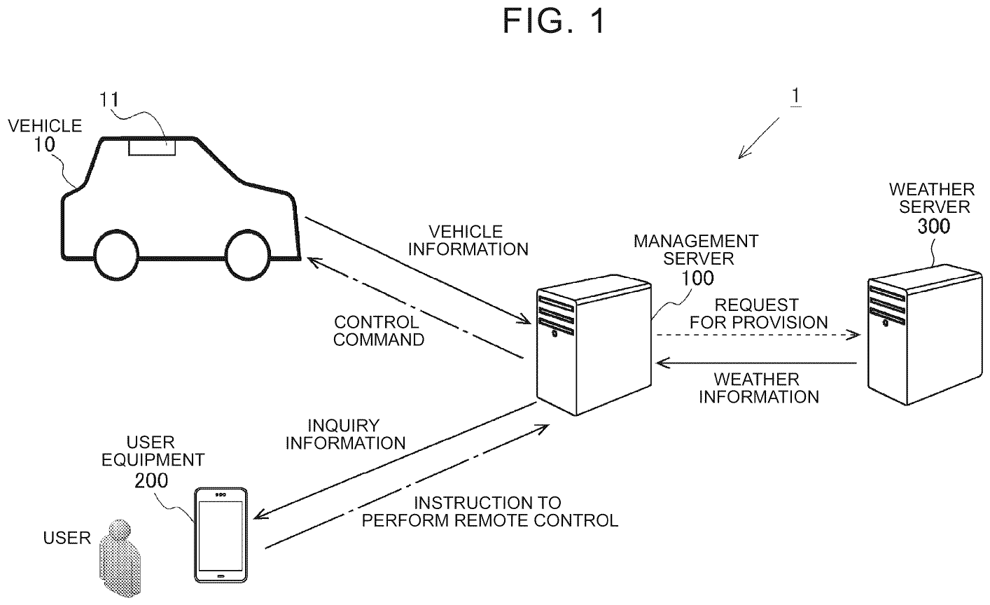

FIG. 1 is a diagram illustrating a flow of information in a remote control system according to the present embodiment. The remote control system 1 is a system for remotely controlling the vehicle 10. The remote control system 1 includes a vehicle 10, a management server 100, user equipment 200, and a weather server 300.

The vehicle 10 is a vehicle that can be subjected to remote control. The vehicle 10 is provided with a sunroof 11 that can be controlled to open and close by remote control. In the present embodiment, the sunroof 11 corresponds to the “open and close roof” according to the present disclosure. However, the “open and close roof” according to the present disclosure is not limited to a sunroof, and may be a top of an open car.

In addition, various sensors for detecting the state of the vehicle 10 are mounted on the vehicle 10. For example, the vehicle 10 is equipped with a Global Positioning System (GPS) receiver that acquires the current location of the vehicle 10. Further, the vehicle 10 is equipped with a load sensor that detects a load applied to each seat in the vehicle cabin (hereinafter, sometimes referred to as a “seat load”).

The user equipment 200 is a terminal associated with a user of the vehicle 10. In the present embodiment, the user equipment 200 is carried by a user who is not in the vehicle 10. The user is, for example, an owner of the vehicle 10. The user may be a driver of the vehicle 10 who parks the vehicle 10 and gets off the vehicle 10. The management server 100 is a server device that remotely controls the vehicle 10. The weather server 300 is a server device that provides weather information such as weather forecast.

Although only one vehicle 10 is illustrated in FIG. 1, a plurality of vehicles 10 may be remotely controlled by the management server 100. In the present embodiment, the management server 100 corresponds to an “information processing device” according to the present disclosure.

The vehicle 10, the management server 100, the user equipment 200, and the weather server 300 are connected to each other via a network. Here, as the network, for example, a Wide Area Network (WAN) that is a public communication network such as the Internet or a telephone communication network such as a mobile telephone may be adopted. The network may also include telephone communication networks for cellular phones and the like, and wireless communication networks such as Wi-Fi (registered trademark).

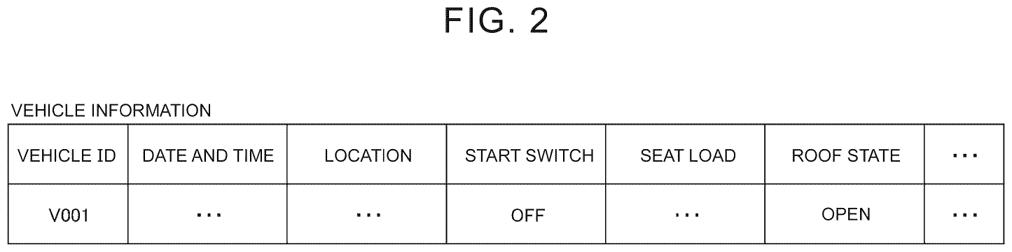

The vehicle 10 sends the vehicle information to the management server 100. Here, the vehicle information is information related to the state of the vehicle 10. FIG. 2 is a diagram showing an example of a table configuration of vehicle information; As shown in FIG. 2, the vehicle information includes a vehicle ID field, a date and time field, a location field, a start switch field, a seat load field, and a roof status field.

A vehicle ID that is identification information for identifying the vehicle 10 is input to the vehicle ID field. In the date and time field, the date and time when the vehicle information is sent from the vehicle 10 is input. In the location field, location information of the current location of the vehicle 10 is input. ON/OFF status of the start switch of the vehicle 10 is inputted to the start switch field. Specifically, in the vehicle 10, if the start switch is ON, the start switch field is input as “ON”, and if the start switch is OFF, the start switch field is input as “OFF”. The seat load of each seat of the vehicle 10 detected by the load sensor is input to the seat load field. The open and closed state of the sunroof 11 is input to the roof state field. Specifically, in the parked vehicle 10, if the sunroof 11 is open, “open” is input to the roof state field, and if the sunroof 11 is closed, “closed” is input to the roof state field. Note that the vehicle information may include information indicating the state of the vehicle 10 other than the above.

The vehicle information may be sent from the vehicle 10 to the management server 100 at a predetermined cycle. When the predetermined condition is satisfied, the vehicle information may be sent from the vehicle 10 to the management server 100. Then, when the vehicle 10 is parked and the user is at a place away from the vehicle 10, the management server 100 sends an inquiry to the user regarding the remote control of the vehicle 10, based on the vehicle information received from the vehicle 10, if the inquiry to the user is necessary. Specifically, the management server 100 sends the inquiry information to the user equipment 200. The inquiry information is information for inquiring the user whether to perform remote control of the vehicle 10.

When receiving the inquiry information from the management server 100, the user equipment 200 displays the inquiry content. Then, when the user determines based on the displayed inquiry content that it is necessary to perform remote control of the vehicle 10, the user inputs this fact to the user equipment 200. In this case, an instruction to perform remote control is sent from the user equipment 200 to the management server 100. Upon receiving the instruction to perform the remote control from the user equipment 200, the management server 100 perform the remote control on the vehicle 10 as instructed. Specifically, the management server 100 sends a control command for remote control to the vehicle 10.

The management server 100 also sends a request for providing weather information around the current location of the vehicle 10 to the weather server 300. Upon receiving the provision request, the weather server 300 sends weather information around the current location of the vehicle 10. The management server 100 refers to the weather information received from the weather server 300 when determining whether it is necessary to inquire the user whether it is necessary to perform remote control of the sunroof 11 of the vehicle 10.

### Configuring Management Server

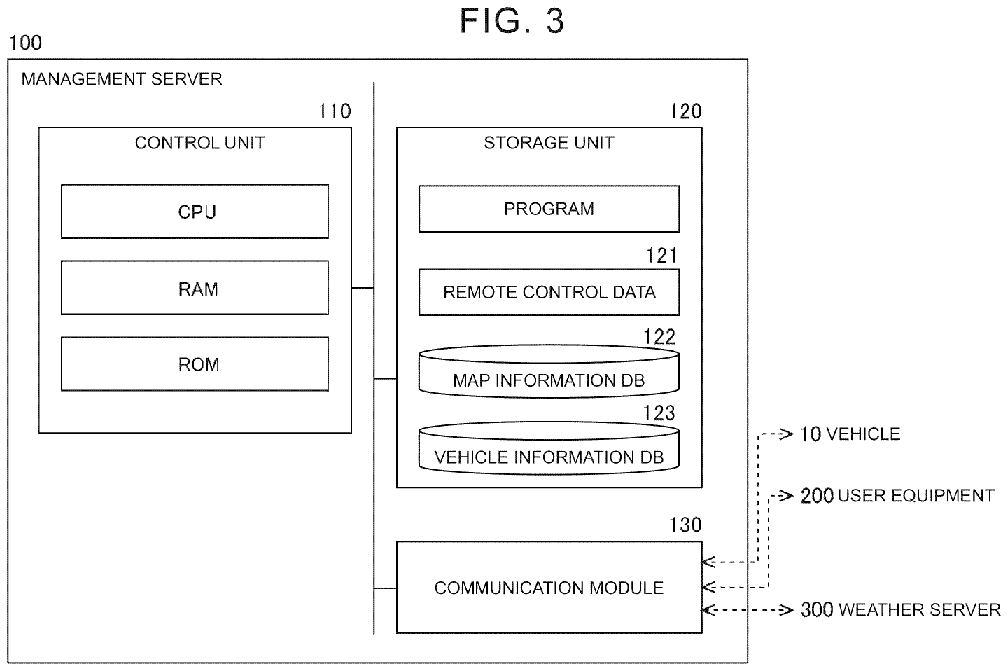

Next, the configuration of the management server 100 will be described. FIG. 3 is a block diagram schematically illustrating a configuration of the management server 100. The management server 100 includes a control unit 110, a storage unit 120, and a communication module 130. The control unit 110 has a function of performing arithmetic processing for controlling the management server 100. The control unit 110 includes a processor such as Central Processing Unit (CPU), a main storage device such as Random Access Memory (RAM), and a secondary storage device such as Read Only Memory (ROM). CPU is an exemplary processor resource. In addition, RAM and ROM are exemplary memory resources. The control unit 110 can perform desired information processing based on various programs and various data. However, some or all of the functions of the control unit 110 may be realized by a hardware circuit such as a ASIC, FPGA.

The storage unit 120 is constituted by any storage device such as a RAM, ROM, a hard disk drive, or a flash memory. The storage unit 120 may include a removable medium (portable recording medium). Here, the removable medium is, for example, a USB memory, a SD card, or a disc recording medium such as a CD-ROM, DVD disc or a Blu-ray disc. The storage unit 120 stores programs to be executed by the control unit 110 and various types of data to be used for executing the programs.

Further, the storage unit 120 stores remote control data 121 used to execute a program for remote control of the vehicle 10. Further, in the storage unit 120, a map information database (a map information DB) 122 and a vehicle information database (a vehicle information DB) 123 are constructed. The map information of the area including the parking location of the vehicle 10 is stored. The vehicle information DB 123 stores vehicle information received from the vehicle 10. When the vehicle information is sent from the plurality of vehicles 10 to the management server 100, the vehicle information is stored in the vehicle information DB for each vehicle 10.

The communication module 130 is a communication interface for connecting the management server 100 to a network. The communication module 130 is, for example, a Local Area Network (LAN) interface board or wireless communication circuitry for wireless communication. The management server 100 communicates with the user equipment 200 and the weather server 300 via the communication module 130.

Similarly to the management server 100, the weather server 300 includes a control unit, a storage unit, and a communication module. In addition, the user equipment 200 has a processor such as a Central Processing Unit (CPU), a main storage device such as a Random Access Memory (RAM), and a secondary storage device such as a Read Only Memory (ROM), and a communication interface for connecting the user equipment 200 to a network. Examples of the user equipment 200 include a smartphone, a tablet computer, a mobile computer, and a wearable computer.

Further, in the present embodiment, the management server 100 is not necessarily realized by a single physical configuration, and may be constituted by a plurality of computers that cooperate with each other. For example, the map information DB 122 and the vehicle information DB 123 may each be constructed in separate computers capable of communicating with each other.

### Flow of Information Processing

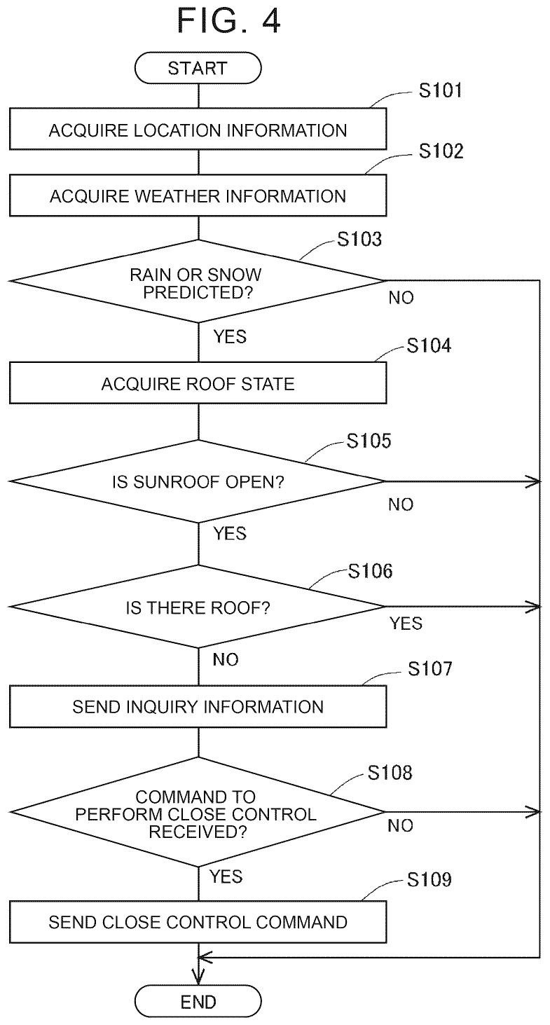

Next, a flow of information processing that is performed by the management server 100 will be described with reference to FIG. 4. FIG. 4 is a flow of information processing related to remote control of the sunroof 11 of the vehicle 10 as a control target. Here, it is assumed that a user is located at a place away from the parked vehicle 10. At this time, when the sunroof 11 of the parked vehicle 10 is open, there is a possibility that rain or snow enters the vehicle when it rains or snows in an area including the parking location. In order to prevent such rain or snow from entering the inside of the vehicle 10, in the present embodiment, the management server 100 performs remote control for controlling the sunroof 11.

When “OFF” is inputted in the start switch field in the latest vehicle information related to the vehicle 10 stored in the vehicle information DB 123, the control unit 110 of the management server 100 determines that the vehicle 10 is currently parked. Further, the control unit 110 of the management server 100 determines whether or not there is an occupant in the vehicle 10 based on the seat load inputted in the seat load field in the latest vehicle information related to the vehicle 10 stored in the vehicle information DB 123. That is, when the seat loads applied to the respective seats of the vehicle 10 are all equal to or less than the predetermined threshold value, the control unit 110 determines that there is no occupant in the vehicle 10 at present. Then, when it is determined that the vehicle 10 is currently parked and there is no occupant in the vehicle 10, the control unit 110 assumes that the user is located at a place away from the parked vehicle 10, and performs the information processing illustrated in FIG. 4.

Note that the method of determining that the vehicle 10 is parking is not limited to the above method. For example, it may be determined that the vehicle 10 is parked based on the shift position in the vehicle 10 and the vehicle speed of the vehicle 10. In addition, the method of determining the presence of the user at a place away from the vehicle 10 is not limited to the above method. For example, it may be determined that the user is located at a place away from the vehicle 10 based on the location information of the user equipment 200 carried by the user.

In this flow, first, in S101, the location information of the vehicle 10 (in other words, the location information of the parking location of the vehicle 10) is acquired from the latest vehicle information regarding the vehicle 10 stored in the vehicle information DB 123. Next, in S102, weather information around the parking location of the vehicle 10 is acquired from the weather server 300 based on the location information of the vehicle 10 acquired by S101. At this time, the control unit 110 sends a request for providing weather information to the weather server 300, and receives the weather information sent from the weather server 300 in response to the request for providing weather information.

Next, in S103, it is determined whether rain or snow is expected around the parking location of the vehicle 10 in the weather data acquired by S102. At this time, the control unit 110 determines that rain or snow is predicted near the parking location when the probability of precipitation within a predetermined time from the current time is equal to or higher than a predetermined threshold in the area identified based on the parking location of the vehicle 10. When neither rain nor snow is predicted around the parking location, it is highly likely that remote control (close control) for the sunroof 11 is unnecessary. Therefore, if a negative determination is made in S103, this process is temporarily terminated. In this case, the remote control of the sunroof 11 of the vehicle 10 is not performed.

On the other hand, if an affirmative determination is made on S103, S104 process is performed next. In S104, the open and closed state of the sunroof 11 of the vehicle 10 (in other words, the open and closed state of the sunroof 11 of the vehicle 10 being parked) is acquired from the latest vehicle information about the vehicle 10 stored in the vehicle information DB 123. Next, in S105, it is determined whether or not the sunroof 11 of the parked vehicle 10 is open based on the open and closed state of the sunroof 11 acquired by S104. When the sunroof 11 of the parked vehicle 10 is in the closed state, remote control (close control) for the sunroof 11 is unnecessary. Therefore, if a negative determination is made in S105, as in the case where a negative determination is made in S103, this process is once terminated.

On the other hand, if an affirmative determination is made on S105, S106 process is performed next. In S106, it is determined whether or not there is a roof covering the vehicle 10 at the parking location. At this time, the control unit 110 acquires the map including the parking location of the vehicle 10 from the map information DB 122. Then, when the parking location of the vehicle 10 overlaps with the location of the building having the roof on the acquired map, the control unit 110 determines that there is a roof covering the vehicle 10 at the parking location. Here, when there is a roof covering the vehicle 10 at the parking location, rain or snow will not enter the vehicle 10 even if it rains or snows on the vehicle 10 with the sunroof 11 open. Therefore, remote control (close control) for the sunroof 11 is unnecessary. Therefore, in a case where an affirmative determination is made in S106, in a case where a negative determination is made in S103, and in a case where a negative determination is made in S105, this process is temporarily terminated.

On the other hand, if S106 is negative, S107 process is performed next. In S107, the inquiry information is sent to the user equipment 200. The inquiry information is information for inquiring the user of the vehicle 10 whether to perform the close control of the sunroof 11. In the user equipment 200, when the inquiry information is received from the management server 100, an inquiry is displayed as to whether it is necessary to perform the close control of the sunroof 11. Then, when the user determines that it is necessary to perform the close control of the sunroof 11, the user inputs the fact to the user equipment 200. In this case, an instruction to perform the close control of the sunroof 11 is sent from the user equipment 200 to the management server 100. On the other hand, when the user determines that it is not necessary to perform the close control of the sunroof 11, the user equipment 200 does not send an instruction to perform the close control of the sunroof 11 to the management server 100.

Therefore, in S108, it is determined whether an instruction to perform the close control of the sunroof 11 is received from the user equipment 200. When a negative determination is made in S108, that is, when an instruction to perform the close control of the sunroof 11 is not received, this process is temporarily terminated. In this case, the remote control (close control) for the sunroof 11 of the vehicle 10 is not performed. On the other hand, if an affirmative determination is made on S108, S109 process is performed next. In S109, a control command to cause the vehicle 10 to perform the close control of the sunroof 11 is sent to the vehicle 10. When a control command is received from the management server 100 in the vehicle 10, the close control of the sunroof 11 is performed.

According to the above flow, the management server 100 closes the sunroof 11 of the vehicle 10 by remote control when an instruction to perform the close control of the sunroof 11 is received from the user. As a result, it is possible to prevent the inside of the vehicle 10 from getting wet due to rain or snow in a situation where there is no roof covering the parked vehicle 10 and the sunroof 11 of the vehicle 10 is open.

On the other hand, even when the sunroof 11 of the parked vehicle 10 is open and rain or snow is predicted around the parking location of the vehicle 10, no inquiry information is sent from the management server 100 to the user equipment 200 when there is a roof covering the vehicle 10. Accordingly, it is possible to reduce the possibility of unnecessary inquiries being made to the user regarding remote control of the sunroof 11. Therefore, according to the present disclosure, it is possible to improve convenience of a user regarding remote control of the sunroof 11 of the vehicle 10.

### Modified Examples

A modified example of the present embodiment will be described hereinbelow. In the present modification, a situation detection sensor that is a sensor for detecting a situation around the vehicle 10 is provided. Here, the situation detection sensor may be, for example, an in-vehicle camera that captures an image of the surroundings of the vehicle 10. The situation detection sensor may be, for example, a sonar that detects an object located around the vehicle 10 by emitting an ultrasonic wave around the vehicle 10.

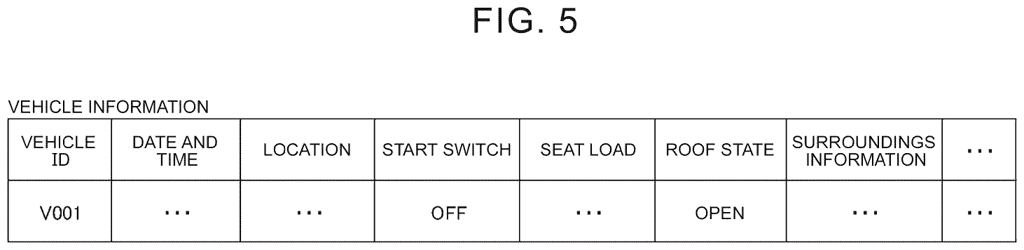

FIG. 5 is a diagram illustrating an example of a table configuration of vehicle information according to a modification of the present embodiment. As shown in FIG. 5, the vehicle information includes a surroundings information field in addition to a vehicle ID field, a date and time field, a location field, a start switch field, a seat load field, and a roof status field. In the surroundings information field, surroundings information indicating the surroundings of the vehicle 10 detected by the situation detection sensor is input.

In this modification, the control unit 110 of the management server 100 acquires the surroundings information from the latest vehicle information related to the vehicle 10 stored in the vehicle information DB 123. Then, the control unit 110 determines whether there is a roof covering the vehicle 10 at the parking location of the vehicle 10 based on the acquired surroundings information in addition to the location information of the parking location of the vehicle 10. According to this, as compared with the case where only the parking location and the map information of the vehicle 10 are used, it is possible to determine with high accuracy whether there is a roof covering the vehicle 10 at the parking location of the vehicle 10. As a result, it is possible to suppress unnecessary inquiries from being made to the user regarding the remote control of the sunroof 11 with higher accuracy.

### Other Embodiments

The above embodiments are merely examples, and the present disclosure may be appropriately modified and implemented without departing from the scope thereof. For example, the processes and means described in the present disclosure can be free combined and implemented as long as no technical contradiction occurs.

Further, the processes described as being performed by one device may be shared and performed by a plurality of devices. Alternatively, the processes described as being performed by different devices may be performed by one device. In the computer system, it is possible to flexibly change the hardware configuration (server configuration) for realizing each function.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. The non-transitory computer-readable storage medium is, for example, a disc of any type such as a magnetic disc (floppy (registered trademark) disc, hard disk drive (HDD), etc.), an optical disc (compact disc read only memory (CD-ROM), digital versatile disc (DVD), Blu-ray disc, etc.), a read only memory (ROM), a random access memory (RAM), an erasable programmable read only memory (EPROM), an electrically erasable programmable read only memory (EEPROM), a magnetic card, a flash memory, or any type of medium suitable for storing electronic commands such as an optical card.

What is claimed is:

1. An information processing device comprising a control unit configured to
acquire location information of a parking location of a target vehicle with a remotely controllable open and close roof,
acquire information on an open and closed state of the open and close roof of the target vehicle,
acquire weather information around the parking location,
when the weather information predicts rain or snow around the parking location and the open and close roof of the target vehicle is open, determine based on the location information whether there is a roof covering the target vehicle at the parking location,
when determination is made that there is no roof covering the target vehicle at the parking location, send inquiry information inquiring whether to close the open and close roof to a user of the target vehicle, and
when an instruction to perform close control of the open and close roof is received from the user in response to the inquiry information, close the open and close roof of the target vehicle by remote control, wherein the control unit does not send the inquiry information when determination is made that there is a roof covering the target vehicle at the parking location.

2. The information processing device according to claim 1, wherein when determining based on the location information whether there is a roof covering the target vehicle at the parking location, the control unit determines that there is a roof covering the target vehicle at the parking location when the parking location overlaps a location of a building with a roof on a map.

3. The information processing device according to claim 1, wherein the control unit is configured to further acquire surroundings information indicating surroundings of the target vehicle detected by a sensor mounted on the target vehicle, and
the control unit determines based on the location information and the surroundings information whether there is a roof covering the target vehicle at the parking location.

4. A system comprising:
user equipment associated with a user of a target vehicle with a remotely controllable open and close roof; and an information processing device, wherein the information processing device is configured to
acquire location information of a parking location of the target vehicle,
acquire information on an open and closed state of the open and close roof of the target vehicle,
acquire weather information around the parking location,
when the weather information predicts rain or snow around the parking location and the open and close roof of the target vehicle is open, determine based on the location information whether there is a roof covering the target vehicle at the parking location,
when determination is made that there is no roof covering the target vehicle at the parking location, send inquiry information inquiring whether to close the open and close roof to the user equipment,
when an instruction to perform close control of the open and close roof is received from the user equipment in response to the inquiry information, close the open and close roof of the target vehicle by remote control, and
the information processing device does not send the inquiry information to the user equipment when determination is made that there is a roof covering the target vehicle at the parking location.

5. The system according to claim 4, wherein:
the information processing device is configured to further acquire surroundings information indicating surroundings of the target vehicle detected by a sensor mounted on the target vehicle; and
the information processing device determines based on the location information and the surroundings information whether there is a roof covering the target vehicle at the parking location.
